(19) United States
(12) Patent Application Publication
(10) Pub. No.: US 2006/0111261 A1
(43) Pub. Date: May 25, 2006

(54) Acidic laundry detergent compositions

(75) Inventors: Eugene Steven Sadlowski, Cincinnati, OH (US); Vincent John Becks, Liberty Township, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/282,897

(22) Filed: Nov. 18, 2005

Related U.S. Application Data
(60) Provisional application No. 60/629,534, filed on Nov. 19, 2004.

(51) Int. Cl. C11D 17/00

(52) U.S. Cl. 510/221

(57) ABSTRACT

Acidic laundry detergent compositions wherein the detergent composition contains a surfactant component; and an organic acid source; and wherein the composition has a viscosity of greater than about 150 mPa·s; wherein the composition has a pH of from about 2 to about 6; and wherein the composition has a reserve acidity of at least 1.6. Methods for reducing fabric dinginess by washing clothes which such detergent compositions.

### CROSS REFERENCE TO RELATED APPLICATION

This Application claims the benefit of U.S. Provisional Application Ser. No. 60/629,534, filed Nov. 19, 2004 (P&G Case 9841P).

### FIELD OF THE INVENTION

The present invention relates to laundry detergent compositions which are capable of delivering an acidic wash pH to the wash water of a standard fabric washing machine.

### BACKGROUND OF THE INVENTION

Numerous laundry treatment compositions are available for use by consumers in the washing of clothing and other fabrics in traditional washing machines. However, consumers still struggle to remove some residues and/or stains from fabric items. Some of the more problematic consumer fabric cleaning problems originate from complex mixtures of accumulated body soils (especially in the underarm and collar areas) with detergent, fabric softener, and hard water residues. Such residues can additionally include other soil, detergent, fabric softener and/or hard water components that were redeposited during previous washes. The build up of these residues over time leads to a loss of whiteness and/or brightness and may create a dingy appearance to fabric.

Detergent compositions, particularly liquid laundry detergents, are formulated to contain one or more surfactants (often anionic surfactants), electrolyte materials, and other adjuvants dispersed or dissolved in an aqueous medium. They are generally formulated to a composition pH of above 7. The main reason for the popularity of a basic pH is to ensure that the surfactant components, enzymes or other organic solvents remain solubilized and disperse in the wash water and that greasy or oily stains removed from soiled clothing are also dispersed in the wash water.

Although a number of acidic detergent formulations (especially hard-surface cleaners) have been available in the past to consumers, the standard and widely-available laundry detergent formulations provide a pH in the range of about 7 to 11. It was traditionally believed that acidic formulations were unsuitable or undesirable for laundry detergent formulations.

Therefore, a need still exists for a laundry detergent formulation that is capable of reducing or eliminating the residues on fabrics associated with mixtures of accumulated body soils, detergent, fabric softener and/or hard water.

### SUMMARY OF THE INVENTION

It has now surprisingly been found that laundry detergents, especially heavy duty liquid laundry detergents that are capable of providing a pH of around 6 in the wash water of a standard washing machine can be useful for breaking up the dingy-causing deposits on fabrics, providing improved grease cleaning and cleaning of bleachable stains like tea and wine. The dingy cleaning effect is similar to the break up of calcium mineral and soap scum deposits on bath tub tiles.

Thus the invention encompasses an acidic laundry detergent composition wherein the detergent composition comprises:

a) a surfactant component; and

b) an organic acid source;

wherein the composition has a viscosity of greater than about 150 mPa·s;

wherein the composition has a pH of from about 2 to about 6; and

wherein the composition has a reserve acidity of at least 1.6.

The invention further encompasses a laundry detergent as above wherein the detergent composition is a liquid laundry detergent composition having a viscosity of from about 150 to about 400 mPa·s.

The invention further encompasses a laundry detergent composition wherein the detergent composition contains

a) from about 5% to about 40% a surfactant component comprising an anionic surfactant;

b) from about 0.5 to about 10% of an organic acid source;

c) less than 1% of enzymes; and

d) less than 1% of fatty acid components; and

wherein the composition has a viscosity of greater than about 150 to about 1,500 mPa·s; wherein the composition has a pH of from about 2.5 to about 6; and wherein the composition has a reserve acidity of at least 1.6.

The invention further encompasses a laundry detergent composition according to above wherein the surfactant component comprises an anionic surfactant.

The invention further encompasses a laundry detergent composition according to above wherein the organic acid source is citric acid.

The invention further encompasses a laundry detergent composition according to above wherein the laundry detergent composition has a reserve acidity of at least 2.4.

The invention further encompasses a laundry detergent composition according to above wherein composition has a pH of from about 6 or less when diluted by about 700%.

The invention further encompasses a laundry detergent composition according to above wherein the composition further comprises from about 0.01% to about 1% of a rheology modifier.

The invention further encompasses a laundry detergent composition according to above wherein the rheology modifier is selected from methylcellulose, hydroxypropylmethylcellulose, xanthan gum, gellan gum, guar gum and hydroxypropyl guar gum, succinoglycan, trihydroxystearin, and mixtures thereof.

The invention further encompasses a laundry detergent composition according to above wherein the rheology modifier is selected from methylcellulose, hydroxypropylmethylcellulose, and mixtures thereof.

The invention further encompasses a laundry detergent composition according to above wherein the surfactant component comprises a surfactant selected from anionic, nonionic, and mixtures thereof.

The invention further encompasses a laundry detergent composition according to above wherein the surfactant component comprises an anionic surfactant and an additional surfactant selected from nonionic, cationic, amphoteric, and mixtures thereof.

The invention further encompasses a laundry detergent composition according to above wherein the composition is substantially free of enzymes.

The invention further encompasses a laundry detergent composition according to above wherein the composition is substantially free of fatty acid compounds.

The invention further encompasses a laundry detergent composition according to above wherein the composition comprises from about 0.5 to about 10% of the organic acid source.

The invention further encompasses a laundry detergent composition according to above wherein the composition further comprises a laundry adjunct material selected from builders, polymers, brighteners, perfumes, and mixtures thereof.

The invention further encompasses a method of laundering fabrics which provides reduction of fabric dinginess, said method comprising the steps of:

a) providing a detergent composition according to above;

b) providing a wash water;

c) introducing said detergent composition into said wash water in an amount sufficient to generate a pH of from about 5 to about 6.5 in the wash water.

The invention further encompasses a method of laundering fabrics according to above wherein after the detergent composition is introduced into the wash water, the wash water comprises from about 0.02 to about 4.0%, by weight of the wash water, of the detergent composition.

The invention further encompasses a method of laundering fabrics which provides reduction of fabric dinginess, said method comprising the steps of:

a) providing a detergent composition according to above;

b) providing a wash water;

c) introducing said detergent composition into said wash water in an amount sufficient to generate a pH of from about 5 to about 6.5 in the wash water.

The invention further encompasses a laundry detergent composition according to above wherein after the detergent composition is introduced into the wash water, the wash water comprises from about 0.04 to about 2.0%, by weight of the wash water, of the detergent composition.

### BRIEF DESCRIPTION OF THE DRAWINGS

FIG. 1—Computer Model for wash water pH showing predicted wash water pH as a function of reserve acidity and tap water alkalinity.

### DETAILED DESCRIPTION OF THE INVENTION

The essential and optional components of laundry treatment compositions herein, as well as composition form, preparation and use, are described in greater detail as follows:

In this description, all concentrations and ratios are on a weight basis of the laundry treatment composition unless otherwise specified. Elemental compositions such as percentage nitrogen (% N) are percentages by weight.

Molecular weights of polymers are number average molecular weights unless otherwise specifically indicated.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included.

Particle size ranges are ranges of median particle size. For example a particle size range of from 0.1 micron to 200 micron refers to the median particle size having a lower bound of 0.1 micron and an upper bound of 200 microns.

Particle size may be measured by means of known techniques such as a laser scattering technique, using a Coulter LS 230 Laser Diffraction Particle Size Analyzer from Coulter Corporation, Miami, Fla., 33196, USA.

All documents cited herein are, in relevant part, incorporated herein by reference. The citation of any document is not to be considered as an admission that it is prior art with respect to the present invention.

All measurements referenced herein are at room temperature (about 21.1° C.) and at atmospheric pressure, unless otherwise indicated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the laundry detergent compositions of the present invention, unless otherwise specified. All such weights as they pertain to listed ingredients exclude carriers, diluents etc. that may occur in commercial forms of the materials, unless otherwise specified.

All documents cited are, in relevant part, incorporated herein by reference; the citation of any document is not to be construed as an admission that it is prior art with respect to the present invention.

Laundry Detergent Composition

The laundry detergent compositions of the present invention may be in solid or liquid form, including a gel form. In one specific embodiment, the compositions are liquid in form and comprise heavy duty liquid compositions.

The laundry detergent compositions of the present invention contain a surfactant, and have a pH of at least 2.0 and when added to wash water, provide a pH of less than about 6.5. The laundry compositions are described in further detail below.

Surfactant Component

The laundry detergent composition comprises a surfactant component in an amount sufficient to provide desired cleaning properties. In one embodiment, the laundry detergent composition comprises, by weight of the composition, from about 5% to about 90% of the surfactant component, and more specifically from about 5% to about 70% of the surfactant component, and even more specifically from about 5% to about 40% of the surfactant component. The surfactant component may comprise anionic, nonionic, cationic, zwitterionic and/or amphoteric surfactants. In a more specific embodiment, the surfactant component comprises anionic surfactant, nonionic surfactant, or mixtures thereof.

The surfactant component of the present invention is substantially free of alkylethoxylates (AES) and fatty carboxylates (fatty acids or salts).

Anionic Surfactant

In one embodiment, the surfactant components herein include from about 5% to about 40%, preferably from about 10% to about 20%, by weight of the detergent composition, of an anionic surfactant component.

Suitable anionic surfactants useful herein include the alkyl benzene sulfonic acids and their salts.

Exemplary anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. In one embodiment, the alkyl benzene sulfonates surfactant is selected from sodium and potassium linear straight chain alkylbenzene sulfonates in which the average number of carbon atoms in the alkyl group is from about 11 to 14. Sodium C₁₁-C₁₄. For example, C₁₂, LAS is a specific example of such surfactants.

Generally speaking, anionic surfactants useful herein are disclosed in U.S. Pat. No. 4,285,841, Barrat et al., issued Aug. 25, 1981, and in U.S. Pat. No. 3,919,678, Laughlin, et al., issued Dec. 30, 1975.

Useful anionic surfactants also include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid group. (Included in the term “alkyl” is the alkyl portion of aryl groups.) Other anionic surfactants useful herein are the water-soluble salts of: paraffin sulfonates and secondary alkane sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil).

Mixtures of the alkylbenzene sulfonates with the above-described paraffin sulfonates, secondary alkane sulfonates and alkyl glyceryl ether sulfonates are also useful.

Nonionic Surfactant

In addition to the anionic surfactant component, the laundry detergent compositions of the present invention may further contain an ethoxylated nonionic surfactant. The compositions of the present invention may contain up to about 30%, in one embodiment from about 0.01% to about 20%, alternatively from about 0.1 % to about 10%, by weight of the detergent composition, of an ethoxylated nonionic surfactant. These materials are described in U.S. Pat. No. 4,285,841, Barrat et al, issued Aug. 25, 1981. In one embodiment, the nonionic surfactant is selected from the ethoxylated alcohols and ethoxylated alkyl phenols of the formula R(OC₂H₄)ₙ OH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. In one embodiment, the nonionic surfactant is selected from ethoxylated alcohols having an average of from about 10 to about 15 carbon atoms in the alcohol and an average degree of ethoxylation of from about 3 to about 12 moles of ethylene oxide per mole of alcohol.

Without being limited by theory, it is believed that the addition of an ethoxylated nonionic surfactant to the detergent compositions of the invention herein is helpful in providing physical stability to the detergent product, i.e., preventing phase splits and precipitation. This is particularly true for compositions containing high levels of quaternary ammonium agent and/or low levels of anionic surfactant. Therefore, one embodiment of the invention herein comprises at least about 0.1%, by weight of the detergent composition, of the nonionic surfactant in the detergent compositions herein.

Suitable nonionic surfactants useful herein can comprise any of the conventional nonionic surfactant types typically used in liquid and/or solid detergent products. These include alkoxylated fatty alcohols and amine oxide surfactants. Preferred for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, alternatively from about 3 to 10 ethylene oxide moieties per molecule.

The alkoxylated fatty alcohol materials useful in the detergent compositions herein will frequently have a hydrophilic-lipophilic balance (HLB) which ranges from about 3 to 17. In one embodiment, the HLB of this material will range from about 6 to 15, alternatively from about 8 to 15. Alkoxylated fatty alcohol nonionic surfactants have been marketed under the tradenames Neodol and Dobanol by the Shell Chemical Company.

Another suitable type of nonionic surfactant useful herein comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, in one embodiment from 10 to 16 carbon atoms, and is alternatively a C₁₂-C₁₆ primary alkyl. R¹ is a short-chain moiety, and may be selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants useful herein include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 to Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

Anionic/Nonionic Combinations

In the laundry detergent compositions herein, the surfactant component may comprise combinations of anionic and nonionic surfactant materials. When this is the case, the weight ratio of anionic to nonionic will typically range from 10:90 to 95:5, more typically from 30:70 to 70:30.

Amphoteric Surfactant

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Cationic Surfactant

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Viscosity

The detergent compositions of the present invention have a viscosity in the range of from about 30 to about 12,000 mPa·s (milli Pascal seconds), alternatively in the range of from about 150 to about 5,000 mPa·s. Preferably, the detergent compositions of the present invention have a viscosity in the range of from about 100 to about 1,500 mPa·s, alternatively from about 150 to about 400 mPa·s. The detergent compositions herein may be in the form of a gel, pourable gels, non-pourable gels, or heavy-duty liquids.

“Gel” as used herein includes a shear thinning gel with a pouring viscosity in the range of from 1,000 to 5,000 mPa·s, in one embodiment less than 3,000 mPa·s, alternatively less than 1,500 mPa·s. Gels may include thick liquids. More generally, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates. The rheology of shear-thinning gels is described in more detail in the literature, see for example WO 04\027010A1 Unilever.

Other compositions according to the present invention are pourable gels having a viscosity of at least 1,500 mPa·s but no more than 6,000 mPa·s, in one embodiment no more than 4,000 mPa·s, alternatively no more than 3,000 mPa·s, alternatively no more than 2,000 mPa·s.

Yet other compositions according to the present invention are non-pourable gels having a viscosity of at least 6,000 mPa·s but no more than 12,000 mPa·s, in one embodiment no more than 10,000 mPa·s, alternatively no more than 8,000 mPa·s and especially no more than 7,000 mPa·s.

Preferred liquid or gel form laundry treatment compositions herein include heavy-duty liquid laundry detergents for use in the wash cycle of automatic washing-machines and liquid finewash and/or color care detergents; these suitably have the following rheological characteristics: viscosity of no more than 1,500 mPa·s, in one embodiment no more than 1,000 mPa·s, alternatively, no more than 500 mPa·s. Very suitable compositions have viscosity of from 150 to 400 mPa·s and are either Newtonian or shear-thinning.

In these definitions and unless specifically indicated to the contrary, all stated viscosities are those measured at a shear rate of 21 s−1 and at a temperature of 25° C. Viscosity herein can be measured with any suitable viscosity-measuring instrument, e.g., a Carrimed CSL2 Rheometer at a shear rate of 21 sec⁻¹.

Organic Acid Source

The detergent compositions contain an acid source in the form of an organic carboxylic acid or polycarboxylic acid. The organic acids preferably have equivalent weights that are less than or equal to about 80. Examples of organic acids that may be used herein include: adipic, aspartic, carboxymethyloxymalonic, carboxymethyloxysuccinic, citric, glutaric, hydroxyethyliminodiacetic, iminodiacetic, maleic, malic, malonic, oxydiacetic, oxydisuccinic, succinic, sulfamic, tartaric, tartaric-disuccinic, tartaric-monosuccinic. Particularly preferred are acids that can also serve as detergent builders such as citric acid. The laundry composition of the present invention contains from about 0.1 to about 15%, by weight of the composition, of the organic acid source. In one embodiment the laundry composition contains from about 0.5 to about 10%, alternatively from about 1 to about 8%, by weight of the composition, of the organic acid source.

Reserve Acidity

As used herein “reserve acidity” refers to the grams of NaOH per 100 g of product required to attain a pH of 7.00. The reserve acidity measurement as used herein is based upon titration (at standard temperature and pressure) of a 1% product solution in distilled water to an end point of pH 7.00 using standardized NaOH solution. Without being limited by theory, the reserve acidity measurement is found to be the best measure of the acidifying power of a composition, or the ability of a composition to provide a target acidic wash pH when added at high dilution into realistic tap water (i.e., tap water that has alkalinity as opposed to pure or distilled water). The reserve acidity is controlled by the level of formulated organic acid along with the neat product pH.

The compositions herein have a reserve acidity of at least 1.6, more preferably at least 2.0, most preferably at least 2.4.

Composition pH

The pH of the detergent composition (measured neat) will be preferably at least 2, more preferably at least 2.3, and most preferably at least 2.5. The pH of the detergent composition (measured neat) is less than about 6. In one embodiment, the pH of the detergent composition (measured neat) is from about about 2 to about 6, alternatively from about 2.5 to about 6.

pH in Wash Water

The detergent compositions of the present invention are capable of delivering a pH to the wash water (“wash water pH”), when the detergent composition is added to the wash water (e.g., of a standard laundry washing machine) is less than 6.5, in one embodiment less than 6.2, alternatively less than 6.0.

In practical terms, the detergent compositions of the present invention are provided to the wash water in a sufficient amount such that the wash water contains from about 0.02 to about 4%, by weight of the wash water, of the detergent composition. In one embodiment, the wash water contains from about 0.03% to about 3%, by weight of the wash water, of the detergerit, alternatively from about 0.04% to about 2% (about 400 to about 2000 ppm).

In one embodiment, the composition has a pH of from about 6 or less when diluted with water by about 700 fold.

Enzymes

The compositions of the present invention may contain less than about 1 % of enzymes, alternatively, the compositions of the present invention may be substantially free of enzymes. As used herein “substantially free of enzymes” means that no enzymes are purposefully added to the formulation, but yet it is understood to one of ordinary skill in the art that trace amounts of enzymes may be present as impurities in other additives.

Where the compositions herein do contain enzymes, the enzymes should be selected from those that are compatible with an acid environment, including proteases, amylases, and mixtures thereof. Examples of acid proteases include Promod® 24L, 144L and 671 L produced by Biocatalysts, and Protease A and Protease B produced by Amano and GC 106 and Fungal Acid Protease 500000 produced by Genencor. Other acid proteases are disclosed in U.S. Pat. No. 6,066,610 and U.S. Pat. No. 6,376,449. Amylases found to be functional under acidic washing conditions include Duramyl, Fungamyl and Natalase produced by Novozymes.

Fatty Acid Components

The compositions of the present invention may contain less than about 1% of fatty acid components, alternatively, the compositions of the present invention may be substantially free of fatty acid components. As used herein “substantially free of fatty acid components” means that no fatty acid components are purposefully added to the formulation, but yet it is understood to one of ordinary skill in the art that trace amounts of fatty acid components may be present as impurities in other additives.

Examples of fatty acids include linear and branched, saturated and mono- and polyunsaturated carboxylic acids having from 8 to 22 carbon atoms and their salts.

Other Laundry Adjuncts

The compositions of the present invention may contain one or more additional laundry adjuncts such as dyes, hueing dyes, chelants, stabilizers, radical scavengers, perfumes, fluorescent whitening agents, suds-supressors, soil-suspension polymers, soil release polymers, dye-transfer inhibitors, fabric softening additives, rheology modifiers, and other polymers.

Dyes

The compositions of the present invention may contain a dye to either provide a particular color to the composition itself (non-fabric substantive dyes) or to provide a hue to the fabric (hueing dyes). In one embodiment, the compositions of the present invention may contain from about 0.0001 to about 0.01% of a non-fabric substantive dye and/or a hueing dye.

Hueing Dye

Examples of hueing dyes useful herein include Basic Violet 3 (Cl 42555) and Basic Violet 4 (Cl 42600), both commercially available from Standard Dyes.

Bleaching Agent

The compositions of the present invention may contain a bleaching agent. In one embodiment, the compositions of the present invention may contain from about 0.10% to about 10%, by weight of the composition, of a bleaching agent.

Bleaching agents useful herein include hydrogen peroxide or peroxyacids such as 6-phthalimidoperoxyhexanoic acid.

Chelants

The compositions of the present invention may contain a chelant. Chelants useful herein include DTPA, HEDP, DTPMP, dipicolinic acid, and mixtures thereof.

Radical Scavenger

The compositions of the present invention may contain a radical scavenger which may be used with liquid hydrogen peroxide to provide stability. Radical scavengers useful herein include trimethoxybenzoic acid.

Perfumes

The compositions of the present invention may contain an acid-stable perfume.

Fluorescent Whitening Agent

The compositions of the present invention may contain a fluorescent whitening agent. Fluorescent whitening agents useful herein include those that are compatible with an acidic environment such as Tinopal CBS-X.

Suds-Supressors

The compositions of the present invention may contain a suds suppressor. In one embodiment, the suds suppressor is a non-fatty acid suds suppressor. Examples of non-fatty acid suds supressors useful herein include silica/silicone type, silicone oil, branched alcohols, and mixtures thereof.

Soil Suspension Polymers

The compositions of the present invention may contain a soil suspension polymer. In one embodiment, the soil suspension polymer is selected from PEI ethoxylates, HMDA diquate ethoxylates, sulfonated derivatives, hydrophobically modified anionic copolymers. Particularly preferred are PEI with MW=182 and an average degree of ethoxylation=15, PEI with MW=600 and an average degree of ethoxylation=20, hexamethylenediamine dimethyquat with an average degree of ethoxylation=24, and hexamethylenediamine dimethyquat with an average degree of ethoxylation=24 (disulfonated). Examples of hydrophobically modified anionic copolymers useful herein include Acusol 480®, commercially available from Rohm and Haas and Alcosperse® 725 and 747, commercially available from Alco Chemical.

Soil Release Polymers

The compositions of the present invention may contain a soil release polymer. In one embodiment, the soil release polymer is a PET alkoxylate short block copolymer, anionic derivative, or mixture thereof.

Dye Transfer Inhibitors

The compositions of the present invention may contain a dye transfer inhibitor and/or a dye fixative. Examples of dye transfer inhibitors useful herein include polyvinylpyrrolidone, poly-4-vinylpyridine-N-oxide, copolymers of N-vinyl-2-pyrrolidone and N-vinylimidazole and mixtures thereof. Useful dye fixatives for this application are disclosed in U.S. Pat. No. 6,753,307.

Fabric Softening Additives

The compositions of the present invention may contain a fabric softening additive. Examples of fabric softening additives useful herein include alkyl quaternary ammonium compounds, ester quaternary ammonium compounds, silicones, cationic silicones, and mixtures thereof.

Rheology Modifiers

The compositions of the present invention may contain a rheology modifier. Rheology modifiers useful herein include methylcellulose, hydroxypropylmethylcellulose, xanthan gum, gellan gum, guar gum and hydroxypropyl guar gum, succinoglycan, and trihydroxystearin. Particularly preferred are methylcellulose and hydroxypropylmethylcellulose thickeners available under the Methocel® trade name from Dow Chemical. When used herein, the detergent compositions of the present invention contain from about 0.01 to about 1%, by weight of the composition, of a rheology modifier. In one embodiment, the compositions herein contain from about 0.02 to about 0.75%, alternatively from about 0.05% to about 0.5%, by weight of the composition, of the rheology modifier.

### EXAMPLES

In the Examples herein, unless otherwise indicated, the detergent ingredients are expressed by weight of the total compositions.

### Example 1

The effects of formula parameters upon wash pH at high wash dilution are measured as follows. 24 formulas are prepared according to Table 1, having citric acid levels ranging from 0.0 to 7.5% and product pH values ranging from 2.43 to 7.59.

TABLE 1

| ingredient | wt % |
|---|---|
| C11.8 linear alkylbenzene sulfonic acid | 17.2 |
| Neodol 23-9 | 10.4 |
| citric acid | 0.0-7.5 |
| DTPA | 0.2 |
| ethanolamine | to adjust pH |
| ethoxylated amine polymer | 2.0 |
| ethanol | 2.0 |
| Tinopal CBS-X | 0.2 |
| perfume | 0.3 |
| water | balance |
| neat pH | 2.43-7.59 |

The reserve acidity was measured for each sample by titration of a 1% solution of each sample in distilled water to a pH end point of 7.00 with standard NaOH solution. The reserve acidity values were calculated as g NaOH/100 g of product. Values ranged from 0.13 to 35.37 g NaOH/100 g of product. Data were analyzed by a stepwise regression technique using JMP5 software to provide a descriptive model of product reserve acidity in terms of citric acid level and product pH:

$$reserve acidity = 2.5570 - 0.5633 ⋆ product pH + 0.2771 ⋆ \% citric acid + 0.0230 ⋆ {( product pH - 4.5092 )}^{2} - 0.1603 ⋆ ( product pH - 4.5092 ) ⋆ ( \% citric acid - 3.3854 ) \qquad ( Equation 1 )$$

3 water samples were prepared having the following hardness and alkalinity values.

TABLE 2

| | hardness, as | |
|---|---|---|
| water | grains/gallon | alkalinity, |
| sample | CaCO3 | as ppm CaCO3* |
| 1 | 0.0 | 2.8 |
| 2 | 6.0 | 67.7 |
| 3 | 12.0 | 142.6 |

*measured using EPA method 310.1

Each of the 24 product samples were added to each of the 3 water samples at 1860 ppm wash concentration (538-fold dilution) and the wash water pH values were measured. Values ranged from 2.66 to 7.72. Wash water pH data were analyzed by a stepwise regression technique using JMP5 software to obtain a descriptive model of wash water pH in terms of product reserve acidity (calculated from equation 1) and tap water alkalinity:

$$wash water pH = 6.0759 + 0.0151 ⋆ tap water alkalinity - 0.5717 ⋆ product reserve acidity - 0.00014 ⋆ {( tap water alkalinity - 71 )}^{2} + 0.00138 ⋆ ( tap water alkalinity - 71 ) ⋆ {( product reserve acidity - 1.0481 )}^{} \qquad ( Equation 2 )$$

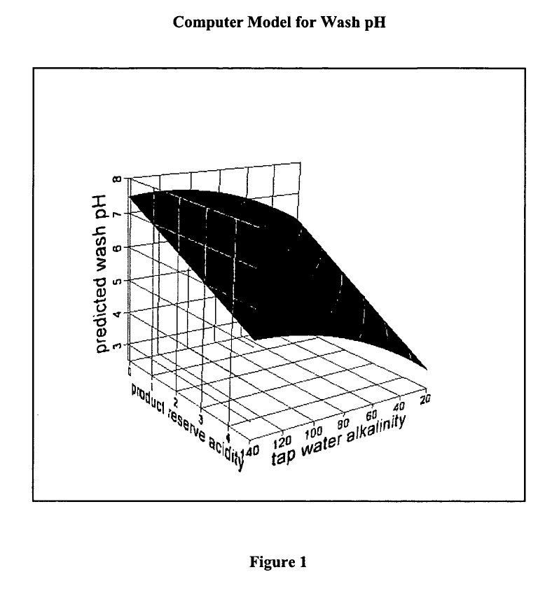

The response surface is shown in FIG. 1. It can be seen that at high dilution, a formula designed to have a reserve acidity ≧2.0 g NaOH/100 g product will produce wash pH's ≦6.5 over a wide range of tap water alkalinity values.

[image]

### Example 2

### Liquid Laundry Detergent Compositions

The following formulations “a” through “h” are prepared by traditional means known to one of ordinary skill and according to the present invention and are set out in Tables 3 and 4.

TABLE 3

| | a | b | c | d |
|---|---|---|---|---|
| ingredient | wt % | wt % | wt % | wt % |
| C11.8 linear | 17.2 | 17.2 | 13.5 | 14.0 |
| alkylbenzene sulfonic | | | | |
| acid | | | | |
| Neodol 23-5 | | | 5.2 | |
| Neodol 23-9 | 10.4 | 10.4 | 5.2 | 8.4 |
| citric acid | 5.0 | 5.0 | 4.5 | 4.1 |
| DTPA¹ | 0.3 | 0.3 | 0.2 | 0.2 |
| ethanolamine | 3.3 | 3.3 | 2.6 | 2.6 |
| sodium hydroxide | 0.6 | to adjust | to adjust | to adjust |
| | | pH | pH | pH |
| ethoxylated | 2.0 | 2.0 | 1.6 | 1.6 |
| amine polymer | | | | |
| ethanol | 2.0 | 2.0 | 2.0 | 2.0 |
| silicone suds | 0.04 | 0.04 | 0.03 | 0.03 |
| suppressor | | | | |
| Tinopal CBS-X | 0.2 | 0.2 | 0.2 | 0.2 |
| perfume | 0.3 | 0.3 | 0.2 | 0.2 |
| Blue EM² | 0.005 | | | |
| Basic Violet | | 0.0005 | | |
| 3 (CI 42555)³ | | | | |
| Basic Violet | | | 0.001 | |
| 4 (CI 42600)⁴ | | | | |
| Acid Blue 7 | | 0.0003 | | |
| (CI 42080)⁵ | | | | |
| thickener | 0.1-0.5 | 0.1-0.5 | 0.1-0.5 | 0.1-0.5 |
| water | balance | balance | balance | balance |
| neat pH (of | 3.2 | 3.2 | 2.5 | 2.7 |
| composition) | | | | |
| reserve acidity⁶ | 2.5 | 2.5 | 2.9 | 2.5 |

¹diethylenetriaminepentaacetic acid, sodium salt
²polymeric colorant from Milliken
^{3,4}fabric hueing dyes
⁵non-fabric substantive dye
⁶g NaOH/100 g of product

TABLE 4

| | e | f | g | h |
|---|---|---|---|---|
| ingredient | wt % | wt % | wt % | wt % |
| C11.8 linear | 6.3 | 6.0 | 3.5 | 12.5 |
| alkylbenzene sulfonic | | | | |
| acid | | | | |
| Neodol 23-9 | 13.7 | 3.0 | 5.5 | 7.5 |
| C12 dimethyl | | 1.0 | 1.0 | |
| amine oxide | | | | |
| citric acid | 4.1 | 3.5 | 5.0 | 3.0 |
| DTPA¹ | 0.2 | 0.1 | 0.1 | 0.3 |
| ethanolamine | 1.2 | 1.1 | 0.7 | 2.4 |
| sodium hydroxide | to adjust | to adjust | to adjust | to adjust |
| | pH | pH | pH | pH |
| ethoxylated | 1.6 | 0.05 | 0.05 | 2.0 |
| amine polymer | | | | |
| ethanol | 2.0 | | | 2.0 |
| silicone suds | 0.02 | | | 0.2 |
| suppressor | | | | |
| Tinopal CBS-X | 0.2 | 0.05 | 0.05 | 0.2 |
| perfume | 0.2 | 0.2 | 0.2 | 0.3 |
| thickener | 0.1-0.5 | 0.1-0.5 | 0.1-0.5 | 0.1-0.5 |
| water | balance | balance | balance | balance |
| neat pH | 3.3 | 2.5 | 3.5 | 3.0 |
| reserve acidity⁶ | 2.0 | 2.25 | 2.25 | 1.7 |

¹diethylenetriaminepentaacetic acid, sodium salt
⁶g NaOH/100 g of product

Example h of Table 4 is a formula designed for use in a high efficiency machine.

### Example 3

### Liquid Laundry Detergent

The effect of the addition of a thickener to the formula of Table 3, example 2a is shown in Table 5.

TABLE 5

| formula | thickener | viscosity |
|---|---|---|
| Table 3, example 2a | none | 161 |
| Table 3, example 2a | 0.1% | 310 |
| | hydroxypropylmethylcellulose⁷ | |
| Table 3, example 2a | 0.1% gellan gum⁸ | 361 |

⁷Methocel 240S (Dow)
⁸Gelrite (C. P. Kelco)

As can be seen from Table 5, the addition of a small amount of a cellulosic or gum thickener can result in a thicker product.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 4

### Liquid Laundry Detergent

The following liquid laundry detergent compositions of the present invention are prepared.

| | 4a | 4b |
|---|---|---|
| LAS | 24.0 | 32.0 |
| C₈-C₁₀ amidopropyl dimethyl amine | 2.0 | 2.0 |
| CFAA | — | 5.0 |
| C₁₂-C₁₄ Fatty alcohol ethoxylate | 12.0 | 6.0 |
| C₁₂-C₁₈ Fatty acid | 3.0 | — |
| Citric acid (anhydrous) | 6.0 | 5.0 |
| Monoethanolamine | to adjust pH | to adjust pH |
| Propanediol | 12.7 | 14.5 |
| Ethanol | 1.8 | 2.4 |
| DTPA | 0.5 | 0.4 |
| Amylase | 0.001 | 0.002 |
| Lipase | 0.1 | — |
| SRP1 | 0.5 | 0.5 |
| Boric acid | 2.4 | 2.4 |
| DC 3225C | 1.0 | 1.0 |
| 2-butyl-octanol | 0.03 | 0.04 |
| Brightener 15 | 0.12 | 0.10 |
| Water | balance | balance |
| Neat pH | 4.2 | 3.8 |

The abbreviated component identifications therein have the following meanings:

LAS Sodium linear C₁₁₋₁₃ alkyl benzene sulfonate.

DTPA Diethylene triamine pentaacetic acid.

Amylase Amylolytic enzyme sold under the tradename Purafact Ox Am^{R} described in WO 94/18314, WO 96/05295 sold by Genencor; Natalase®, Termamyl®, Fungamyl® and Duramyl®, all available from Novozymes A/S.

Lipase Lipolytic enzyme sold under the tradename Lipolase Lipolase Ultra by Novozymes A/S and Lipomax by Gist-Brocades.

Brightener 1 Disodium 4,4′-bis(2-sulphostyryl)biphenyl.

SRP 1 Anionically end capped poly esters.

DC3225C Silicone suds suppresser, mixture of Silicone oil and Silica from Dow Corning.

CFAA C₁₂-C₁₄ alkyl N-methyl glucamide

pH Measured as a 1% solution in distilled water at 20° C.

What is claimed is:

1. An acidic laundry detergent composition wherein the detergent composition comprises:
a) a surfactant component; and
b) an organic acid source;
wherein the composition has a viscosity of greater than about 150 mPa·s;
wherein the composition has a pH of from about 2 to about 6; and
wherein the composition has a reserve acidity of at least 1.6.

2. A laundry detergent composition according to claim 1 wherein the detergent composition is a liquid laundry detergent composition having a viscosity of from about 150 to about 400 mPa·s.

3. A laundry detergent composition according to claim 1 wherein the surfactant component comprises an anionic surfactant.

4. A laundry detergent composition according to claim 2 wherein the organic acid source is citric acid.

5. A laundry detergent composition according to claim 2 wherein the composition is capable of providing a wash water pH, when added to the wash water, of less than about 6.5.

6. A laundry detergent composition according to claim 1 wherein the laundry detergent composition has a reserve acidity of at least 2.4.

7. A laundry detergent composition according to claim 1 wherein the composition has a pH of from about 6 or less when diluted by about 700%.

8. A laundry detergent composition according to claim 2 wherein the composition further comprises from about 0.01% to about 1% of a rheology modifier.

9. A laundry detergent composition according to claim 8 wherein the rheology modifier is selected from methylcellulose, hydroxypropylmethylcellulose, xanthan gum, gellan gum, guar gum and hydroxypropyl guar gum, succinoglycan, trihydroxystearin, and mixtures thereof.

10. A laundry detergent composition according to claim 9 wherein the rheology modifier is selected from methylcellulose, hydroxypropylmethylcellulose, and mixtures thereof.

11. A laundry detergent composition according to claim 1 wherein the surfactant component comprises a surfactant selected from anionic, nonionic, and mixtures thereof.

12. A laundry detergent composition according to claim 2 wherein the surfactant component comprises an anionic surfactant and an additional surfactant selected from nonionic, cationic, amphoteric, and mixtures thereof.

13. A laundry detergent composition according to claim 2 wherein the composition is substantially free of enzymes.

14. A laundry detergent composition according to claim 2 wherein the composition is substantially free of fatty acid compounds.

15. A laundry detergent composition according to claim 1 wherein the composition comprises from about 0.5 to about 10% of the organic acid source.

16. A laundry composition according to claim 2 wherein the composition further comprises a laundry adjunct material selected from builders, polymers, brighteners, perfumes, and mixtures thereof.

17. An acidic liquid laundry detergent composition wherein the detergent composition comprises:
a) from about 5% to about 40% a surfactant component comprising an anionic surfactant;
b) from about 0.5 to about 10% of an organic acid source;
c) less than 1% of enzymes; and
d) less than 1% of fatty acid components; and
wherein the composition has a viscosity of greater than about 150 to about 1,500 mPa·s;
wherein the composition has a pH of from about 2.5 to about 6; and
wherein the composition has a reserve acidity of at least 1.6.

18. A laundry detergent composition according to claim 17 wherein the composition is capable of providing a wash water pH, when added to the wash water, of less than about 6.5.

19. A laundry detergent composition according to claim 21 wherein the laundry detergent composition has a reserve acidity of at least 2.4.

20. A laundry detergent composition according to claim 17 wherein the composition has a pH of from about 6 or less when diluted by about 700%.

21. A method of laundering fabrics which provides reduction of fabric dinginess, said method comprising the steps of:
a) providing a detergent composition according to claim 1;
b) providing a wash water;
c) introducing said detergent composition into said wash water in an amount sufficient to generate a pH of from about 5 to about 6.5 in the wash water.

22. A method according to claim 31 wherein after the detergent composition is introduced into the wash water, the wash water comprises from about 0.02 to about 4.0%, by weight of the wash water, of the detergent composition.

23. A method of laundering fabrics which provides reduction of fabric dinginess, said method comprising the steps of:
a) providing a detergent composition according to claim 16;
b) providing a wash water;
c) introducing said detergent composition into said wash water in an amount sufficient to generate a pH of from about 5 to about 6.5 in the wash water.
